(19) United States
(12) Patent Application Publication
(10) Pub. No.: US 2026/0111217 A1
(43) Pub. Date: Apr. 23, 2026

(54) FIRMWARE MODE SWITCHING METHOD AND APPARATUS, ELECTRONIC DEVICE, AND STORAGE MEDIUM

(71) Applicant: Suzhou MetaBrain Intelligent Technology Co., Ltd., Suzhou, Jiangsu (CN)

(72) Inventors: Changlei ZHAO, Suzhou, Jiangsu (CN); Wenzheng Qin, Suzhou, Jiangsu (CN); Zuogang Yin, Suzhou, Jiangsu (CN); Jianing Cui, Suzhou, Jiangsu (CN); Hanqing Li, Suzhou, Jiangsu (CN); Qi Zhang, Suzhou, Jiangsu (CN)

(21) Appl. No.: 19/167,671

(22) PCT Filed: May 24, 2024
(86) PCT No.: PCT/CN2024/095266

§ 371 Date: Sep. 22, 2025

(30) Foreign Application Priority Data
Feb. 5, 2024 (CN) 202410162162.9

(51) Int. Cl. G06F 8/71; G06F 11/10; G06F 11/14

(52) U.S. Cl. CPC G06F 8/71; G06F 11/1068; G06F 11/1441

(57) ABSTRACT

The present application provides a firmware mode switching method and apparatus, an electronic device, and a storage medium, belonging to the technical field of computers. The method includes: receiving a firmware activation command sent by a host, where the firmware activation command is configured to instruct a target solid state disk to write firmware of a first mode into a non-volatile storage medium corresponding to a target slot; determining whether the first mode is consistent with a current firmware mode of the target solid state disk, performing, in response to inconsistency, a firmware switching check according to the firmware activation command, and writing the firmware of the first mode into the non-volatile storage medium corresponding to the target slot after the firmware switching check pass; executing a reset operation, and loading the firmware of the first mode; and initializing the firmware of the first mode.

### CROSS-REFERENCE TO RELATED APPLICATION

This application claims priority to Chinese Patent Application No. 202410162162.9, filed on Feb. 5, 2024 in China National Intellectual Property Administration and entitled “Firmware Mode Switching Method and Apparatus, Electronic Device, and Storage Medium”, which is hereby incorporated by reference in its entirety.

### FIELD

The present application relates to the technical field of computers, and particularly to a firmware mode switching method and apparatus, an electronic device, and a storage medium.

### BACKGROUND

With development of information technology, people's demand for data generation and acquisition is increasing. Traditional mechanical hard disk drives (HDD) may no longer meet speed requirements for data storage and acquisition. Application of a solid state disk (SSD) is increasing, and a solution based on a non-volatile memory express (NVME) protocol, that is, a zoned namespaces (ZNS) SSD, has advantages such as better performance, more flexible capacity adjustment, and lower energy consumption as compared with a traditional SSD, and is suitable for storage scenarios that require high performance, high reliability, and scalability.

Current business demands for the SSD are diverse, with demands for both a standard SSD and the ZNS SSD. However, due to differences in metadata organization of blocks between a standard disk mode and a ZNS mode, the firmware of the SSD is entirely different. As business evolves, the demands for two types of the SSD may render a phenomenon of complementary fluctuation. To save hardware costs, it is desirable to use a same set of hardware for both the ZNS SSD and the standard SSD, whereby the firmware may be switched and upgraded. That is, based on business needs, a related SSD may be switched between modes without purchasing a new SSD.

### SUMMARY

In one aspect, the present application provides a firmware mode switching method, including:
receiving, by a target solid state disk, a firmware activation command sent by a host, the firmware activation command configured to instruct the target solid state disk to write firmware of a first mode into a non-volatile storage medium corresponding to a target slot;
determining, by the target solid state disk, whether the first mode is consistent with a current firmware mode of the target solid state disk, performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass;
executing, by the target solid state disk, a reset operation, and loading the firmware of the first mode; and
initializing, by the target solid state disk, the firmware of the first mode.

According to the firmware mode switching method provided by the present application, the first mode is a standard disk mode, and the current firmware mode of the target solid state disk is a Zoned namespaces mode; or the first mode is the Zoned namespaces mode, and the current firmware mode of the target solid state disk is the standard disk mode.

According to the firmware mode switching method provided by the present application, the firmware activation command carries to-be-replaced slot information and a firmware effect manner.

According to the firmware mode switching method provided by the present application, the performing a firmware switching check according to the firmware activation command includes:
checking whether a dual-mode firmware switch is turned on;
checking configuration content of the firmware of the first mode; and
checking whether the to-be-replaced slot information in the firmware activation command is the target slot, and whether the firmware effect manner specified in the firmware activation command is resetting a controller.

According to the firmware mode switching method provided by the present application, after the writing the firmware of the first mode into the non-volatile storage medium corresponding to the target slot, the method further includes:
erasing partial metadata in the non-volatile storage medium, recording position information of the target slot, and configuring a firmware switching flag in the non-volatile storage medium to a first preset value,
where the partial metadata is metadata for which there is a difference between metadata corresponding to the firmware of the first mode and metadata corresponding to firmware of an original mode of the target solid state disk.

According to the firmware mode switching method provided by the present application, the executing, by the target solid state disk, a reset operation includes:
receiving, by the target solid state disk, a subsystem reset instruction sent by the host, and determining whether the firmware switching flag in the non-volatile storage medium is the first preset value; resetting the controller of the target solid state disk in response to the firmware switching flag in the non-volatile storage medium being the first preset value; or executing a subsystem reset procedure in response to the firmware switching flag in the non-volatile storage medium not being the first preset value.

According to the firmware mode switching method provided by the present application, the initializing the firmware of the first mode includes:
determining whether the firmware switching flag in the non-volatile storage medium is the first preset value, and executing steps below in response to determining the firmware switching flag in the non-volatile storage medium being the first preset value:
rebuilding a program erase table of the firmware of the first mode according to an original program erase table, and inheriting an original bad block table; and
changing a power-on state to first-time power-on, and updating the firmware switching flag in the non-volatile storage medium to a second preset value after power-on initialization of all hardware units is successful.

According to the firmware mode switching method provided by the present application, after the step of initializing the firmware of the first mode, the method further includes:
receiving, by the target solid state disk, an instruction to load a non-volatile memory express driver issued by the host; and
loading, by the target solid state disk, the non-volatile memory express driver, in response to the instruction to load the non-volatile memory express driver;

According to the firmware mode switching method provided by the present application, the target slot is slot1.

According to the firmware mode switching method provided by the present application, the non-volatile storage medium is a Nor-type flash memory (Nor flash). According to the firmware mode switching method provided by the present application, the dual-mode firmware switch is implemented by customizing a set feature of a non-volatile memory express protocol.

According to the firmware mode switching method provided by the present application, the method further includes:
configuring a state of the dual-mode firmware switch to ON; and
taking the target slot as a slot for dual-mode firmware switching.

According to the firmware mode switching method provided by the present application, the first mode is determined according to the current firmware mode of the target solid state disk, and the firmware of the first mode is downloaded by the host into a memory of the target solid state disk.

According to the firmware mode switching method provided by the present application, the step of configuring a state of the dual-mode firmware switch to ON includes:
configuring a value of the set feature to 1 to configure the state of the dual-mode firmware switch to ON.

According to the firmware mode switching method provided by the present application, the slot1 is a read-only slot.

According to the firmware mode switching method provided by the present application, the to-be-replaced slot information is a slot targeted by the current dual-mode firmware switching, and the firmware effect manner is an effect manner after firmware switching.

In another aspect, the present application further provides a firmware mode switching apparatus, including:
a receiving unit, configured to receive a firmware activation command sent by a host, where the firmware activation command is configured to instruct a target solid state disk to write firmware of a first mode into a non-volatile storage medium corresponding to a target slot;
a firmware writing unit, configured to determine whether the first mode is consistent with a current firmware mode of the target solid state disk, perform, in response to the first mode being inconsistent with the current firmware mode of the target solid state disk, a firmware switching check according to the firmware activation command, and write the firmware of the first mode into the non-volatile storage medium corresponding to the target slot after the firmware switching check pass;
a reset unit, configured to execute a reset operation, and load the firmware of the first mode; and
an initializing unit, configured to initialize the firmware of the first mode.

The present application further provides an electronic device, including one or more processors; and a storage device associated with the one or more processors, where the storage device is configured to store computer readable instructions; and the computer readable instructions, when read and executed by the one or more processors, implement any one of the firmware mode switching method as described above.

In still another aspect, the present application further provides a non-transitory computer readable storage medium, having computer readable instructions stored thereon, where the computer readable instructions, when executed by one or more processors, implement any one of the firmware mode switching methods as described above.

In yet another aspect, the present application further provides a computer program product, including computer readable instructions, where the computer readable instructions, when executed by one or more processors, implement any one of the firmware mode switching methods as described above.

The firmware mode switching method and apparatus, the electronic device, and the storage medium provided by the present application involve receiving the firmware activation command sent by the host, performing the firmware switching check, and writing the firmware of the first mode into the non-volatile storage medium corresponding to the target slot after the firmware switching check pass; executing the reset operation, and loading the firmware of the first mode; and initializing the firmware of the first mode.

### BRIEF DESCRIPTION OF THE DRAWINGS

In order to clearly describe the technical solutions in the present application or in the related art more clearly, drawings required to be used in the embodiments or the illustration of the related art will be briefly introduced below. Apparently, the drawings in the illustration below are only some embodiments of the present application. A person skilled in the art may also obtain other drawings according to these drawings without creative efforts.

FIG. 1 is a schematic flowchart of a firmware mode switching method provided by some embodiments of the present application;

FIG. 2 is a schematic flowchart of updating new firmware in the firmware mode switching method provided by some embodiments of the present application;

FIG. 3 is a schematic flowchart after reloading the new firmware in the firmware mode switching method provided by some embodiments of the present application;

FIG. 4 is a schematic diagram of a firmware switching function logic provided by some embodiments of the present application;

FIG. 5 is a schematic structural diagram of a firmware mode switching apparatus provided by some embodiments of the present application;

FIG. 6 is a schematic diagram of a physical structure of an electronic device provided by some embodiments of the present application;

FIG. 7 is a schematic structural diagram of a non-transitory computer readable storage medium provided by some embodiments of the present application; and

FIG. 8 is a schematic structural diagram of a computer program product provided by some embodiments of the present application.

### DETAILED DESCRIPTION

In order to make objects, technical details, and advantages of the present application apparent, technical solutions of the present application will be clearly and completely described in conjunction with drawings in the present application. It is obvious that described embodiments are just a part but not all of the embodiments of the present application. Based on the embodiments described herein, all other embodiments obtained by a person skilled in the art without any creative efforts shall fall within the scope of the present application.

With development of information technology, people's demand for data generation and acquisition is increasing. Traditional mechanical hard disk drives (HDD) may no longer meet speed requirements for data storage and acquisition. Application of a solid state disk (SSD) is increasing, and a solution based on a non-volatile memory express protocol, that is, a zoned namespaces (ZNS) SSD, has advantages such as better performance, more flexible capacity adjustment and lower energy consumption than the traditional SSD, and is suitable for storage scenarios that require high performance, high reliability, and scalability.

Current business demands for the SSD are diverse, with demands for both a standard SSD and the ZNS SSD. However, due to differences in metadata organization of blocks between a standard disk mode and a zoned namespaces mode, the firmware of the SSD is entirely different. As business evolves, the demands for the two types of the SSD may render a phenomenon of complementary fluctuation. To save hardware costs, it is desirable to use the same set of hardware for both the ZNS SSD and the standard SSD, whereby the firmware may be switched and upgraded. That is, based on business needs, a related SSD may be switched between modes without purchasing a new SSD.

In the related art, when a firmware mode needs to be switched, an SSD manufacturer is first contacted, and the SSDs are uniformly returned to a warehouse of the SSD manufacturer. The SSD manufacturer then uniformly transports these disks to a production workshop to perform factory-level burning on new firmware, perform systematic safety tests, and ship the disks to the customer after the tests pass. The customer needs to arrange personnel to readapt these disks to their business. The entire procedure is cumbersome and time-consuming, requires a lot of technical personnel to participate, and involves business interactions between the SSD manufacturer and the customer, consuming considerable time and labor costs.

An online upgrade solution of a standard non-volatile memory express protocol is as follows: downloading new firmware to a memory of the SSD; activating the new firmware through a firmware activation command; and resetting a controller of the SSD through subsystem reset to load the new firmware and complete mode switching.

The present application is implemented through a custom firmware processing procedure based on the above-described online upgrade solution.

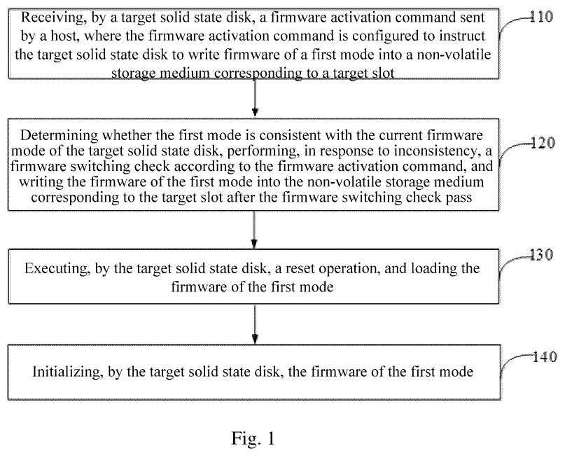

A firmware mode switching method and apparatus, an electronic device, and a storage medium according to the present application are described below with reference to FIG. 1 to FIG. 6.

FIG. 1 is a schematic flowchart of a firmware mode switching method provided by some embodiments of the present application. As shown in FIG. 1, the method includes steps of: step 110, step 120, step 130, and step 140. The steps of the method serve as one possible implementation of the present application. The method includes:

Step 110: receiving, by a target solid state disk, a firmware activation command sent by a host, where the firmware activation command is configured to instruct the target solid state disk to write firmware of a first mode into a non-volatile storage medium corresponding to a target slot.

To reduce labor and time costs for customers and SSD manufacturers, the solution of the present application is implemented based on standard non-volatile memory express protocol online upgrade commands and custom commands. According to the standard non-volatile memory express protocol, compatibility across different platforms and systems may be achieved.

A set feature of the non-volatile memory express protocol is first selected, a feature identity document (ID) of the field is customized, and the feature is customized as a dual-mode firmware switch.

That is, the dual-mode firmware switch is implemented by customizing the set feature of the non-volatile memory express protocol. By customizing set feature of a non-volatile memory express protocol as the dual-mode firmware switch, when the dual-mode firmware switch is in an “ON” state, it indicates that the target solid state disk is capable of executing the dual-mode firmware switching function.

The dual-mode firmware switch is implemented by customizing the set feature of the non-volatile memory express protocol, whereby SSDs of different platforms and systems may be determined to implement the solution of the present application, demonstrating good compatibility.

Through a set feature command, attributes of an indicated Feature may be specified.

In some embodiments, after selecting a set feature of a non-volatile memory express protocol as the dual-mode firmware switch, the method further includes:
configuring a state of the dual-mode firmware switch to ON; and taking the target slot as a slot for dual-mode firmware switching.

In one or more embodiments, configuring a value of the customized feature to 1 indicates turning on the dual-mode firmware switch; and configuring the value of the customized feature to 0 indicates turning off the dual-mode firmware switch.

It should be noted that the customized feature is configured to become invalid upon power-down, that is, if the feature is configured to 1 and the SSD encounters power-down in this case, the value of the feature will be 0 upon next power-on.

In a case where the dual-mode firmware switch is turned on, the target slot is selected as a slot for dual-mode firmware switching. In some embodiments, the target slot is slot1.

Since the standard non-volatile memory express protocol supports multiple slots, the slot1 corresponds to the firmware when the solid state disk leaves the factory. Therefore, in order to implement the dual-mode firmware switching, operations need to be performed on the slot1.

In the standard non-volatile memory express protocol, the slot1 is a read-only slot. In the present application, the standard non-volatile memory express protocol is reused. When the dual-mode firmware switch is turned on, the slot1 may perform dual-mode firmware switching; otherwise, a slot1 read-only attribute error is returned.

After executing the above-described operations, the host downloads the firmware of the first mode into a memory of the target solid state disk. That is, the firmware of the first mode is downloaded by the host into the memory of the target solid state disk, and in one or more embodiments, downloaded into the double data rate (DDR) memory of the target solid state disk.

Then, the host issues a firmware activation command to the target solid state disk to write the firmware of the first mode into the non-volatile storage medium corresponding to the target slot.

It should be noted that during the process of the host downloading the firmware, in the SSD, whether the firmware length exceeds a limit range is checked, without checking other items.

The target solid state disk receives the firmware activation command sent by the host. The firmware activation command is configured to instruct the target solid state disk to write the firmware of the first mode into the non-volatile storage medium corresponding to the target slot.

The first mode is determined according to the current firmware mode of the target solid state disk, and the first mode is different from the current firmware mode of the target solid state disk.

In some embodiments, the first mode is a standard disk mode, and the current firmware mode of the target solid state disk is a zoned namespaces mode. That is, the dual-mode firmware switching according to the present application refers to switching the firmware mode of the target solid state disk from the zoned namespaces mode to the standard disk mode.

In other embodiments, the first mode is the zoned namespaces mode, and the current firmware mode of the target solid state disk is the standard disk mode. That is, the dual-mode firmware switching according to the present application refers to switching the firmware mode of the target solid state disk from the standard disk mode to the zoned namespaces mode.

Here, the standard disk mode refers to that the SSD firmware produced by a solid state disk manufacturer is standard firmware, which adopts standardized software design, complies with the non-volatile memory express protocol, and conforms to industry standards and specifications.

The ZNS SSD represents a new functional division between host software and the SSD. The ZNS SSD divides the capacity thereof into zones; which may be read in an arbitrary order but be written sequentially. These characteristics allow ZNS SSD to improve internal data placement thereof, thereby obtaining better performance.

Compared with the standard SSD, the ZNS SSD has following advantages.
1) Optimized sequential write performance: the ZNS SSD adopts sequential writing, which may significantly reduce write amplification across the entire disk and improve the service life of SSD.
2) Better compatibility: the ZNS SSD may adjust capacity without disk restructuring, which reduces potential compatibility problems during the adjustment process.

3) Faster read/write speed: due to smaller mapping tables and less dynamic random access memory (DRAM) cache of the ZNS SSD, the read/write speed may be significantly improved while reducing latency.

4) Lower energy consumption: the ZNS SSD adopts special storage management mechanism, which may reduce the number of disk activities, thereby lowering energy consumption.
5) More flexible capacity adjustment: the ZNS SSD may adjust capacity without restructuring the disk, making capacity expansion more flexible and convenient.

In some embodiments, the firmware activation command carries to-be-replaced slot information and a firmware effect manner. Here, the to-be-replaced slot information refers to a slot targeted by the current dual-mode firmware switching.

The firmware effect manner refers to an effect manner after firmware switching.

In the embodiments of the present application, by receiving the firmware activation command sent by the host, the target solid state disk may implement firmware mode switching while sharing a same set of hardware.

Step 120: determining, by the target solid state disk, whether the first mode is consistent with the current firmware mode of the target solid state disk, performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass.

It may be understood that after receiving the firmware activation command, the target solid state disk determines whether the first mode is consistent with the current firmware mode of the target solid state disk; in response to the first mode being inconsistent with the current firmware mode of the target solid state disk, it indicates that firmware switching is required, and the firmware switching check is performed according to the to-be-replaced slot information and the firmware effect manner carried by the firmware activation command.

In response to the first mode being consistent with the current firmware mode of the target solid state disk, it indicates that no firmware switching is required, and the procedure is ended.

After receiving the firmware activation command, the target solid state disk determines whether the first mode is consistent with the current firmware mode of the target solid state disk. After determining that the first mode is inconsistent with the current firmware mode of the target solid state disk, the firmware switching check operation is performed, which may avoid unnecessary firmware switching operations.

In some embodiments, the performing a firmware switching check according to the firmware activation command includes: checking whether the dual-mode firmware switch is turned on; checking configuration content of the firmware of the first mode; and checking whether the to-be-replaced slot information in the firmware activation command is the target slot, and whether the firmware effect manner specified in the firmware activation command is resetting a controller.

In one or more embodiments, firstly, it is checked whether the dual-mode firmware switch is turned on. If the dual-mode firmware switch is turned on may subsequent operations be performed.

The checking configuration content of the firmware of the first mode includes: checking whether a device ID and a vendor ID meet expectations; checking whether a firmware encryption key matches; and checking capacity, etc. It is checked whether the to-be-replaced slot information in the firmware activation command is the target slot, that is, the slot1. It is checked whether the firmware effect manner is resetting the controller.

After the above-described firmware switching check pass, the firmware of the first mode is written into the non-volatile storage medium corresponding to the target slot, that is, the firmware of the first mode is updated to the slot1 position of the non-volatile storage medium.

In the embodiments of the present application, updating the firmware of the first mode to the slot1 position of the non-volatile storage medium after the firmware switching check pass may ensure smooth implementation of subsequent firmware switching steps and improve firmware switching efficiency.

In some embodiments, the non-volatile storage medium is Nor Flash. The Nor flash reads and writes slowly but offers good stability.

In some embodiments, after the writing the firmware of the first mode into the non-volatile storage medium corresponding to the target slot, the method further includes:
erasing partial metadata in the non-volatile storage medium, recording position information of the target slot, and configuring a firmware switching flag in the non-volatile storage medium to a first preset value.

The partial metadata is metadata for which there is a difference between metadata corresponding to the firmware of the first mode and metadata corresponding to firmware of an original mode of the target solid state disk.

It should be noted that after writing the firmware of the first mode into the non-volatile storage medium corresponding to the target slot, when the SSD is powered on, the firmware will generate metadata corresponding to the firmware of the first mode. Since the first mode is different from the current firmware mode of the target solid state disk, the metadata generated by the two will also differ. There are some differentiated data between the two. In the embodiments of the present application, the differentiated data is referred to as partial metadata.

The partial metadata needs to be erased and restored to a default initialization state. Because of characteristics of the non-volatile storage medium Nor flash, the corresponding data needs to be erased firstly before writing new data.

The purpose of recording the position information of the target slot is to read firmware content through the position recorded in a metadata slot in the non-volatile storage medium after the controller of the target solid state disk is reset.

After reading the firmware content, the firmware switching flag in the non-volatile storage medium is configured to a first preset value. The first preset value is configured to indicate whether to directly reset an SSD controller. In one or more embodiments, in response to determining the firmware switching flag in the non-volatile storage medium as 1, the controller of the target solid state disk is directly reset. In response to determining the firmware switching flag in the non-volatile storage medium as 0, the normal subsystem reset procedure is executed, and the controller of the target solid state disk is reset through the host issuing a subsystem reset instruction.

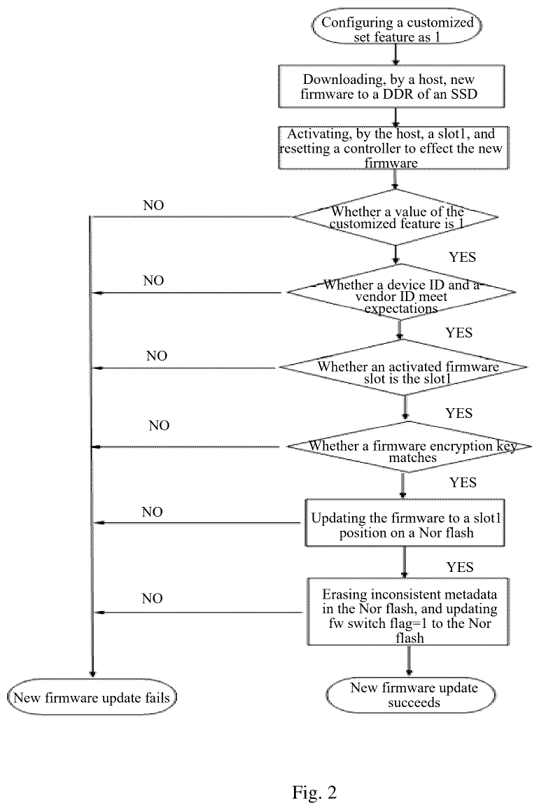

FIG. 2 is a schematic flowchart of updating new firmware in the firmware mode switching method provided by the embodiments of the present application. Updating the new firmware refers to writing the firmware of the first mode into the non-volatile storage medium corresponding to the target slot.

As shown in FIG. 2, the procedure of updating the new firmware includes the steps of:
customizing a feature as a dual-mode firmware switch; downloading, by the host, the firmware of the first mode into a memory of the target solid state disk in response to the dual-mode firmware switch feature value being 1; sending, by the host, a firmware activation command to the target SDD, the firmware activation command being configured to instruct the target solid state disk to store the firmware of the first mode in the memory of the target solid state disk into the non-volatile storage medium Nor flash.

Executing, by the target solid state disk, steps below, after receiving the firmware activation command: checking whether the dual-mode firmware switch is turned on; checking the configuration content of the firmware of the first mode (including checking whether the device identifier and the vendor ID meet expectations, and whether a firmware encryption key matches); checking whether the to-be-replaced slot information in the firmware activation command is the slot1, and whether the firmware effect manner is resetting the controller; and writing the firmware of the first mode into the Nor flash at the slot1; and erasing the metadata in the Nor flash that differs between the firmware of the first mode and initial firmware of the target solid state disk, restoring the different metadata to the default initialization state; updating the activation slot value for the firmware in the metadata to 1; and configuring the value of the firmware switch flag (fw_switch_flag) in the Nor flash to 1, indicating that the new firmware is successfully updated.

In these embodiments of the present application, the target solid state disk performs a firmware switching check after receiving the firmware activation command, and writes the firmware of the first mode into the non-volatile storage medium corresponding to the target slot after the check pass, which may improve stability of firmware update and implement firmware update.

Step 130: executing, by the target solid state disk, a reset operation, and loading the firmware of the first mode;

In some embodiments, the executing, by the target solid state disk, a reset operation includes:
receiving, by the target solid state disk, a subsystem reset instruction sent by the host, determining whether the firmware switching flag in the non-volatile storage medium is the first preset value, resetting the controller of the target solid state disk in response to determining the firmware switching flag in the non-volatile storage medium being the first preset value, and executing a normal subsystem reset procedure in response to determining the firmware switching flag in the non-volatile storage medium not being the first preset value.

It may be understood that after the target solid state disk writes the firmware of the first mode into the non-volatile storage medium of the target solid state disk, erases partial metadata in the non-volatile storage medium, records the position information of the target slot, and configures the firmware switching flag in the non-volatile storage medium to the first preset value, the host sends a subsystem reset instruction to the target solid state disk. Upon receiving the subsystem reset instruction sent by the host, reset is performed on the target solid state disk. There are two modes of performing reset on the target solid state disk: one is resetting the controller of the target solid state disk, and the other is executing the normal subsystem reset procedure, to reset the controller of the target solid state disk through the normal subsystem reset procedure. After the controller of the target solid state disk is reset, the firmware of the first mode is loaded.

In these embodiments of the present application, the target solid state disk executes the reset operation and loads the firmware of the first mode, implementing online switching of the firmware mode.

Step 140: initializing, by the target solid state disk, the firmware of the first mode.

After loading the firmware of the first mode, the target solid state disk initializes the firmware of the first mode.

In some embodiments, the initializing the firmware of the first mode includes: determining whether the firmware switching flag in the non-volatile storage medium is the first preset value, and executing steps below in response to determining the firmware switching flag in the non-volatile storage medium being the first preset value: rebuilding a program erase table of the firmware of the first mode according to an original program erase table, and inheriting an original bad block table; and changing a power-on state to first-time power-on, and updating the firmware switching flag in the non-volatile storage medium to a second preset value after power-on initialization of all hardware units is successful.

In one or more embodiments, the firmware switching flag in the non-volatile storage medium is updated to 0. It should be noted that after the target solid state disk is powered on, data on the nand flash will be erased. Because the mode of the SSD firmware has been replaced to the first mode, the data on the nand flash (NAND flash) should be forcibly erased.

The original program erase (PE) table refers to an erase count table for the nand flash particles within the target solid state disk.

In the embodiments of the present application, the firmware of the first mode is initialized after loading the firmware of the first mode on the target solid state disk, which may avoid returning the SSD to the factory. Switching may be completed just in the computer room of the customer, which may reduce manual involvement and save labor costs, whereby the customer implements switching the firmware of the SSD from the standard disk mode to the zoned namespaces mode, or from the zoned namespaces mode to the standard disk mode, without restarting the server or manually plugging/unplugging the SSD. Furthermore, the present application adopts the standard non-volatile memory express protocol, which is compatible with different server platform systems.

In some embodiments, the method further includes: receiving, by the target solid state disk, an instruction to load a non-volatile memory express driver issued by the host, after initialization of the firmware of the first mode is completed; and loading, by the target solid state disk, the non-volatile memory express driver, in response to the instruction to load the non-volatile memory express driver.

After the new firmware is initialized, the host will issue an instruction to load the non-volatile memory express driver; and after the SSD loads the driver, the host may recognize the SSD, which signifies a success of firmware mode switching.

It should be noted that during the firmware switching process, the target solid state disk should not experience power-down. Otherwise, the target solid state disk may fail to recognize the disk, thereby requiring returning to the SSD manufacturer for factory processing.

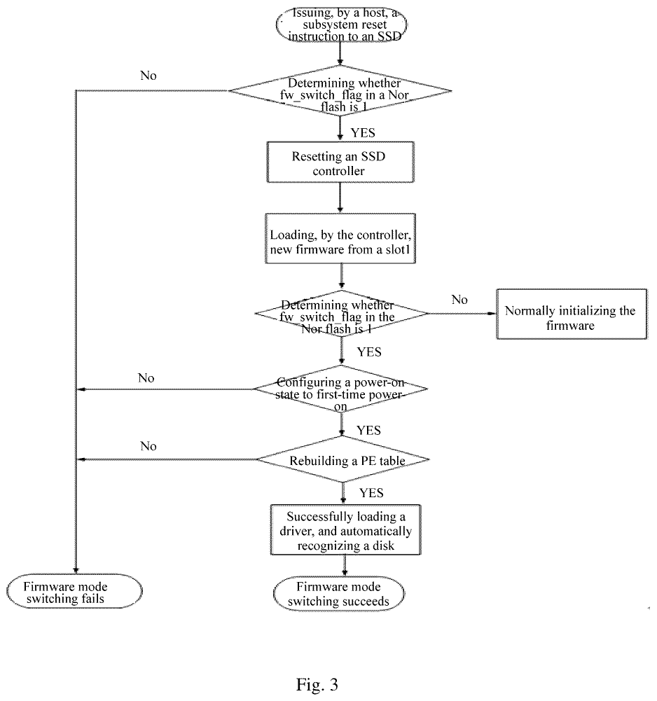

FIG. 3 is a schematic flowchart after reloading the new firmware in the firmware mode switching method provided by the embodiments of the present application. As shown in FIG. 3, a procedure after reloading the new firmware includes steps of:
determining whether the firmware switching flag in the Nor flash is 1, after the controller of the target solid state disk is reset and the firmware of the first mode is loaded; and executing steps below in response to determining the firmware switching flag in the Nor flash as 1:
rebuilding a program erase table of the new firmware according to an original program erase table, and inheriting the original bad block table; changing a power-on state to first-time power-on, and changing the firmware switching flag in the Nor flash to 0 after power-on initialization of all hardware units is successful; and issuing, by the host, an instruction to load the Non-volatile memory express driver, after initialization of the firmware of the first mode is completed; and loading, by the target solid state disk, the driver.

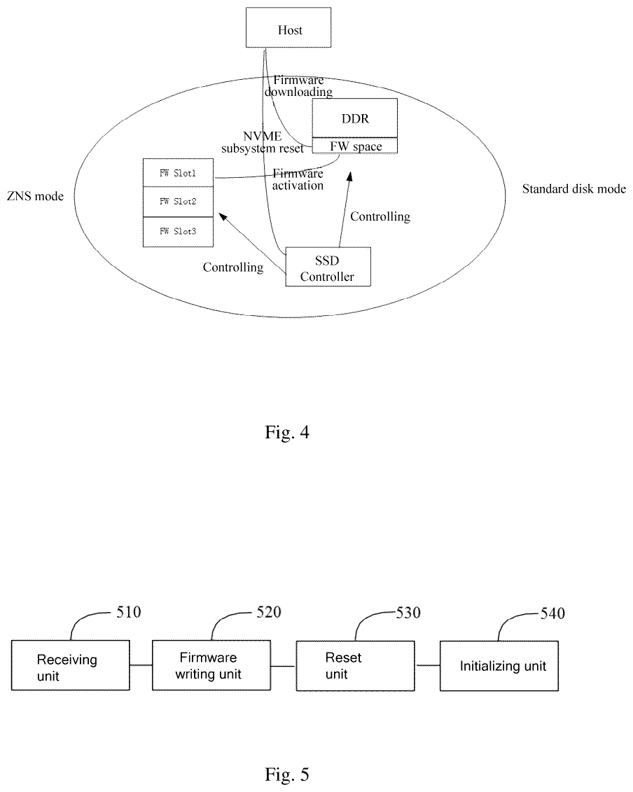

FIG. 4 is a schematic diagram of a firmware switching function logic provided by some embodiments of the present application. As shown in FIG. 4, the host downloads the firmware of the first mode into the DDR of the SSD; and the SSD writes the firmware of the first mode into the slot1. The host controls reset of the controller of the SSD.

In other embodiments of the present application, the firmware mode switching method includes the steps of:
selecting a set feature of the non-volatile memory express protocol, customizing a feature ID of a field, and customizing the feature as the dual-mode firmware switch; selecting the slot1 as a slot for dual-mode firmware switching, in a case where the dual-mode firmware switch is turned on; downloading, by the host, the firmware of the first mode into a memory of the target solid state disk; sending, by the host, a firmware activation command to the target SDD, the firmware activation command being configured to instruct the target solid state disk to store the firmware of the first mode in the memory of the target solid state disk into the non-volatile storage medium Nor flash at the slot1.

Executing, by the target solid state disk, steps below, after receiving the firmware activation command: checking whether the dual-mode firmware switch is turned on; checking the configuration content of the firmware of the first mode; checking whether the to-be-replaced slot information in the firmware activation command is the slot1, and whether the firmware effect manner is resetting the controller; and writing the firmware of the first mode into the Nor flash at the slot1, and the check is complemented; erasing the metadata in the Nor flash that differs between the firmware of the first mode and initial firmware of the target solid state disk, restoring the different metadata to the default initialization state; updating the activation slot value for the firmware in the metadata to 1; and configuring the value of the firmware switch flag in the Nor flash to 1; issuing, by the host, a subsystem reset instruction; determining, by the target solid state disk, whether the firmware switching flag in the Nor flash is 1 in response to receiving the subsystem reset instruction; resetting the controller of the target solid state disk, in response to determining the firmware switching flag in the Nor flash as 1; and executing the normal subsystem reset procedure in response to determining the firmware switching flag in the Nor flash not as 1.

Determining, after the controller of the target solid state disk is reset and the firmware of the first mode is loaded, whether the firmware switching flag in the Nor flash is 1; and executing steps below in response to determining the firmware switching flag in the Nor flash as 1:
rebuilding a program erase table of the new firmware according to an original program erase table, and inheriting the original bad block table; changing a power-on state to first-time power-on, and changing the firmware switching flag in the Nor flash to 0 after power-on initialization of all hardware units is successful; and issuing, by the host, an instruction to load the Non-volatile memory express driver, after initialization of the firmware of the first mode is completed; and loading, by the target solid state disk, the driver.

The firmware mode switching method provided by the embodiments of the present application involves receiving the firmware activation command sent by the host, performing the firmware switching check, and writing the firmware of the first mode into the non-volatile storage medium corresponding to the target slot after the firmware switching check pass; executing the reset operation, and loading the firmware of the first mode; and initializing the firmware of the first mode, thereby implementing online switching of the firmware mode, which may avoid returning the SSD to the factory. Online switching of the firmware mode may be completed just in the computer room of the customer, whereby the customer implements switching the firmware of the SSD from the standard disk mode to the zoned namespaces mode, or from the zoned namespaces mode to the standard disk mode, without restarting the server or manually plugging/unplugging the SSD, which may reduce manual involvement and save labor costs. Furthermore, the present application adopts the standard non-volatile memory express protocol, which is compatible with different server platform systems.

It should be noted that each implementation of the present application may be freely combined, swapped in order, or executed separately, without relying on or requiring a fixed execution sequence.

A firmware mode switching apparatus provided by the present application will be described below. The firmware mode switching apparatus described below corresponds to the firmware mode switching method described above, and the descriptions may be cross-referenced.

FIG. 5 is a schematic structural diagram of a firmware mode switching apparatus provided by some embodiments of the present application. As shown in FIG. 5, the firmware mode switching apparatus includes:
a receiving unit 510, configured to receive a firmware activation command sent by a host, the firmware activation command configured to instruct a target solid state disk to write firmware of a first mode into a non-volatile storage medium corresponding to a target slot; a firmware writing unit 520, configured to determine whether the first mode is consistent with the current firmware mode of the target solid state disk, perform, in response to the first mode being inconsistent with the current firmware mode of the target solid state disk, a firmware switching check according to the firmware activation command, and write the firmware of the first mode into the non-volatile storage medium corresponding to the target slot after the firmware switching check pass; a reset unit 530, configured to execute a reset operation, and load the firmware of the first mode; and an initializing unit 540, configured to initialize the firmware of the first mode.

In some embodiments, the first mode is a standard disk mode and the current firmware mode of the target solid state disk is a zoned namespaces mode; or the first mode is the zoned namespaces mode and the current firmware mode of the target solid state disk is the standard disk mode.

In some embodiments, the firmware activation command carries to-be-replaced slot information and a firmware effect manner.

In some embodiments, the performing a firmware switching check according to the firmware activation command includes: checking whether a dual-mode firmware switch is turned on; checking configuration content of the firmware of the first mode; and checking whether the to-be-replaced slot information in the firmware activation command is the target slot, and whether the firmware effect manner specified in the firmware activation command is resetting a controller.

In some embodiments, the apparatus further includes a first processing unit, configured to: erase partial metadata in the non-volatile storage medium, record position information of the target slot, and configure a firmware switching flag in the non-volatile storage medium to a first preset value; where the partial metadata is metadata for which there is a difference between metadata corresponding to the firmware of the first mode and metadata corresponding to firmware of an original mode of the target solid state disk.

In some embodiments, the executing a reset operation includes: receiving a subsystem reset instruction sent by the host, and determining whether the firmware switching flag in the non-volatile storage medium is the first preset value; resetting the controller of the target solid state disk in response to determining the firmware switching flag in the non-volatile storage medium being the first preset value; or executing a normal subsystem reset procedure in response to determining the firmware switching flag in the non-volatile storage medium not being the first preset value.

In some embodiments, the initializing the firmware of the first mode includes:
determining whether the firmware switching flag in the non-volatile storage medium is the first preset value, and executing steps below in response to determining the firmware switching flag in the non-volatile storage medium being the first preset value; and rebuilding a program erase table of the firmware of the first mode according to an original program erase table, and inheriting an original bad block table; changing a power-on state to first-time power-on, and updating the firmware switching flag in the non-volatile storage medium to a second preset value after power-on initialization of all hardware units is successful.

In some embodiments, the apparatus further includes a driver loading unit, configured to: receive an instruction to load a non-volatile memory express driver issued by the host; and load the non-volatile memory express driver, in response to the instruction to load the non-volatile memory express driver.

In some embodiments, the target slot is slot1. In some embodiments, the non-volatile storage medium is Nor flash.

In some embodiments, the dual-mode firmware switch is implemented by customizing a set feature of a non-volatile memory express protocol.

In some embodiments, the apparatus further includes a second processing unit, configured to: configure a state of the dual-mode firmware switch to ON; and take the target slot as a slot for dual-mode firmware switching.

In some embodiments, the firmware of the first mode is downloaded by the host into a memory of the target solid state disk.

It should be noted here that the firmware mode switching apparatus provided by the embodiments of the present application is capable of implementing all the method steps implemented by the above-described firmware mode switching method embodiments and may achieve the same technical effects. Therefore, the same parts and advantageous effects as the method embodiments in these embodiments will not be repeated here.

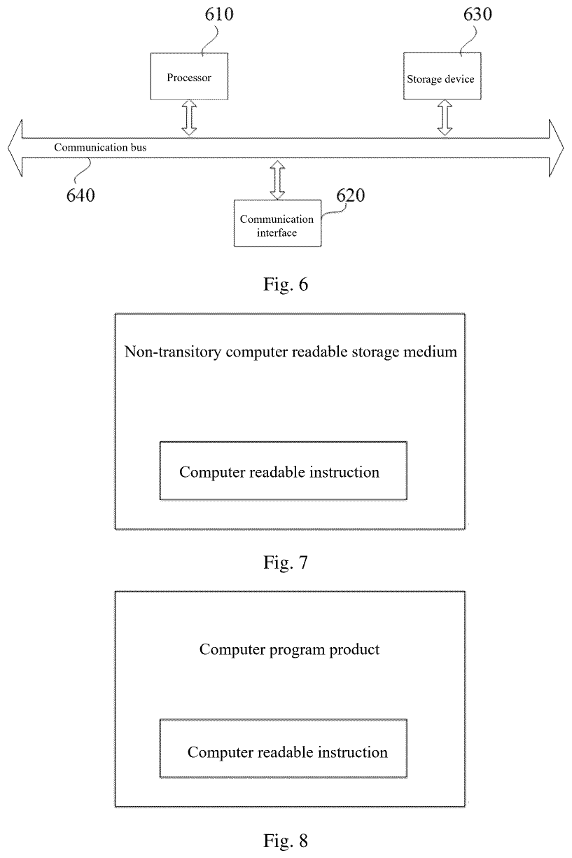

FIG. 6 illustrates a schematic diagram of a physical structure of an electronic device. As shown in FIG. 6, the electronic device may include: one or more processors 610, a communication interface 620, a storage device 630 associated with the one or more processors 610, and a communication bus 640. The processor 610, the communication interface 620, and the storage device 630 communicate with each other via the communication bus 640. The processor 610 may invoke logical instructions in the storage device 630 to execute the firmware mode switching method; and the method includes: receiving a firmware activation command sent by a host, where the firmware activation command is configured to instruct the target solid state disk to write firmware of a first mode into a non-volatile storage medium corresponding to a target slot; determining whether the first mode is consistent with the current firmware mode of the target solid state disk, performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass; executing a reset operation, and loading the firmware of the first mode; and initializing the firmware of the first mode.

Furthermore, when implemented in a form of software functional units and sold or used as independent products, the logical instructions in the above-described storage device 630 may be stored in a computer readable storage medium. Based on such understanding, the essential part of the above-described technical solution of the present application or the part contributing to the related art may be embodied in the form of a software product. The computer software product is stored in a storage medium and includes several instructions whereby a computer device (which may be a personal computer, a server, or a network device, etc.) executes all or part of the steps of the methods according to the respective embodiments of the present application. The foregoing storage medium includes: USB flash drives, portable hard drives, read-only memory (ROM), random access memory (RAM), magnetic disks, optical discs, and various other media that may store program codes.

In another aspect, as shown in FIG. 8, the present application further provides a computer program product. The computer program product includes computer readable instructions; the computer readable instructions may be stored on a non-transitory computer readable storage medium. The computer readable instructions, when executed by one or more processors, may cause a computer to execute the firmware mode switching method provided by the above-described respective methods. The method includes: receiving a firmware activation command sent by a host, where the firmware activation command is configured to instruct the target solid state disk to write firmware of a first mode into a non-volatile storage medium corresponding to a target slot; determining whether the first mode is consistent with the current firmware mode of the target solid state disk, performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass; executing a reset operation, and loading the firmware of the first mode; and initializing the firmware of the first mode.

In yet another aspect, as shown in FIG. 7, the present application further provides a non-transitory computer readable storage medium, having computer readable instructions stored thereon. The computer readable instructions, when executed by one or more processors, implement to execute the firmware mode switching method provided by the above-described respective methods. The method includes: receiving a firmware activation command sent by a host, where the firmware activation command is configured to instruct the target solid state disk to write firmware of a first mode into a non-volatile storage medium corresponding to a target slot; determining whether the first mode is consistent with the current firmware mode of the target solid state disk, performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass; executing a reset operation, and loading the firmware of the first mode; and initializing the firmware of the first mode.

It should be noted that the apparatus embodiments as described above are only schematic, where the units described as separate parts may or may not be physically separated, and the parts displayed as units may or may not be physical units, i.e., they may be located in one place, or may also be distributed to a plurality of network units. According to actual needs, some or all of the modules may be selected to achieve the objective of the solution of this embodiment. A person skilled in the art may understand and implement without any inventive work.

Through the description of the above implementations, a person skilled in the art may clearly understand that each implementation may be implemented by means of software plus a necessary general hardware platform, and certainly may also be implemented through hardware. Based on such understanding, the essential part of the above-described technical solution or the part contributing to the related art may be embodied in the form of a software product. The computer software product may be stored in a computer readable storage medium, for example, ROM/RAM, magnetic disks, optical discs, etc., and includes several instructions to cause a computer device (which may be a personal computer, a server, or a network device, etc.) to execute the methods according to the respective embodiments or certain parts of the embodiments. Finally, it should be noted that the above embodiments are only used for explaining the technical solution of the present application, and not intended to limit the same. Although the present application is explained in detail with reference to the foregoing embodiments, those ordinarily skilled in the art will readily appreciate that: they may still make modifications to the technical solutions recorded in the respective foregoing embodiments, or make equivalent substitutions for part of technical features; however, these modifications or substitutions are not intended to make the essences of the corresponding technical solutions depart from the spirit and the scope of the technical solutions of the respective embodiments of the present application.

1. A firmware mode switching method, comprising:
receiving, by a target solid state disk, a firmware activation command sent by a host, the firmware activation command configured to instruct the target solid state disk to write firmware of a first mode into a non-volatile storage medium corresponding to a target slot;
determining, by the target solid state disk, whether the first mode is consistent with a current firmware mode of the target solid state disk;
performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass, wherein the first mode is a standard disk mode, and the current firmware mode of the target solid state disk is a zoned namespaces mode, or the first mode is the zoned namespaces mode, and the current firmware mode of the target solid state disk is the standard disk mode;
executing, by the target solid state disk, a reset operation, and loading the firmware of the first mode; and
initializing, by the target solid state disk, the firmware of the first mode.

2. (canceled)

3. The firmware mode switching method according to claim 1, wherein the firmware activation command carries to-be-replaced slot information and a firmware effect manner.

4. The firmware mode switching method according to claim 3, wherein the performing a firmware switching check according to the firmware activation command comprises:
checking whether a dual-mode firmware switch is turned on;
checking configuration content of the firmware of the first mode; and
checking whether the to-be-replaced slot information in the firmware activation command is the target slot, and whether the firmware effect manner specified in the firmware activation command is resetting a controller of the target solid state disk.

5. The firmware mode switching method according to claim 4, wherein after the writing the firmware of the first mode into the non-volatile storage medium corresponding to the target slot, the method further comprises:
erasing partial metadata in the non-volatile storage medium, recording position information of the target slot, and configuring a firmware switching flag in the non-volatile storage medium to a first preset value; wherein the partial metadata is metadata for which there is a difference between metadata corresponding to the firmware of the first mode and metadata corresponding to firmware of an original mode of the target solid state disk.

6. The firmware mode switching method according to claim 5, wherein the executing, by the target solid state disk, a reset operation comprises:
receiving, by the target solid state disk, a subsystem reset instruction sent by the host, and determining whether the firmware switching flag in the non-volatile storage medium is the first preset value;
resetting the controller of the target solid state disk in response to the firmware switching flag in the non-volatile storage medium being the first preset value, and
executing a subsystem reset procedure in response to the firmware switching flag in the non-volatile storage medium not being the first preset value.

7. The firmware mode switching method according to claim 6, wherein the initializing the firmware of the first mode comprises:
determining whether the firmware switching flag in the non-volatile storage medium is the first preset value, and executing steps below in response to the firmware switching flag in the non-volatile storage medium being the first preset value:
rebuilding a program erase table of the firmware of the first mode according to an original program erase table, and inheriting an original bad block table; and
changing a power-on state to first-time power-on, and updating the firmware switching flag in the non-volatile storage medium to a second preset value after power-on initialization of all hardware units is successful.

8. The firmware mode switching method according to claim 7, wherein after the initializing the firmware of the first mode, the method further comprises:
receiving, by the target solid state disk, an instruction to load a non-volatile memory express driver issued by the host; and
loading, by the target solid state disk, the non-volatile memory express driver in response to the instruction to load the non-volatile memory express driver.

9. The firmware mode switching method according to claim 1, wherein the target slot is slot1.

10. The firmware mode switching method according to claim 1, wherein the non-volatile storage medium is a Nor-type flash memory (Nor flash).

11. The firmware mode switching method according to claim 4, wherein the dual-mode firmware switch is implemented by customizing a set feature of a non-volatile memory express protocol.

12. The firmware mode switching method according to claim 11, wherein the method further comprises:
configuring a state of the dual-mode firmware switch to ON; and
taking the target slot as a slot for dual-mode firmware switching.

13. The firmware mode switching method according to claim 1, wherein the first mode is determined according to the current firmware mode of the target solid state disk, and the firmware of the first mode is downloaded by the host into a memory of the target solid state disk.

14. The firmware mode switching method according to claim 12, wherein the configuring a state of the dual-mode firmware switch to ON comprises:
configuring a value of the set feature to 1 to configure the state of the dual-mode firmware switch to ON.

15. The firmware mode switching method according to claim 9, wherein the slot is a read-only slot.

16. The firmware mode switching method according to claim 3, wherein the to-be-replaced slot information is a slot targeted by a current dual-mode firmware switching, and the firmware effect manner is an effect manner after a firmware switching.

17. (canceled)

18. An electronic device, comprising:
one or more processors; and
a storage device associated with the one or more processors, wherein the storage device is configured to store computer readable instructions, and the computer readable instructions, when read and executed by the one or more processors, implement a firmware mode switching method comprising:
receiving, by a target solid state disk, a firmware activation command sent by a host, the firmware activation command configured to instruct the target solid state disk to write firmware of a first mode into a non-volatile storage medium corresponding to a target slot;
determining, by the target solid state disk, whether the first mode is consistent with a current firmware mode of the target solid state disk;
performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass, wherein the first mode is a standard disk mode, and the current firmware mode of the target solid state disk is a zoned namespaces mode, or the first mode is the zoned namespaces mode, and the current firmware mode of the target solid state disk is the standard disk mode;
executing, by the target solid state disk, a reset operation, and loading the firmware of the first mode; and
initializing, by the target solid state disk, the firmware of the first mode.

19. A non-transitory computer readable storage medium, having computer readable instructions stored thereon, wherein the computer readable instructions, when executed by one or more processors, implement a firmware mode switching method comprising:
receiving, by a target solid state disk, a firmware activation command sent by a host, the firmware activation command configured to instruct the target solid state disk to write firmware of a first mode into a non-volatile storage medium corresponding to a target slot;
determining, by the target solid state disk, whether the first mode is consistent with a current firmware mode of the target solid state disk;
performing, in response to the first mode being inconsistent with the current firmware mode of the target solid state disk, a firmware switching check according to the firmware activation command, and writing the firmware of the first mode into the non-volatile storage medium corresponding to the target slot after the firmware switching check pass, wherein the first mode is a standard disk mode, and the current firmware mode of the target solid state disk is a zoned namespaces mode, or the first mode is the zoned namespaces mode, and the current firmware mode of the target solid state disk is the standard disk mode;
executing, by the target solid state disk, a reset operation, and loading the firmware of the first mode; and
initializing, by the target solid state disk, the firmware of the first mode.

20. (canceled)

21. The firmware mode switching method according to claim 11, wherein an online upgrade solution of a standard non-volatile memory express protocol is as follows:
downloading new firmware to a memory of the target solid state disk;
activating the new firmware through the firmware activation command; and
resetting the controller of the target solid state disk through subsystem reset to load the new firmware and complete mode switching.

22. The firmware mode switching method according to claim 14, wherein the set feature is configured to become invalid upon power-down.

23. The firmware mode switching method according to claim 5, wherein after the recording position information of the target slot, the method further comprises:
reading firmware content through the position information of the target slot recorded in a metadata slot in the non-volatile storage medium after the controller of the target solid state disk is reset.
